(19) United States
(12) Patent Application Publication
(10) Pub. No.: US 2014/0266739 A1
(43) Pub. Date: Sep. 18, 2014

(54) HEALTH MONITORING AND WARNING SYSTEM

(71) Applicant: DIGIO2 INTERNATIONAL CO., LTD., Miaoli (TW)

(72) Inventor: Kun-Sung Chen, MIAOLI (TW)

(73) Assignee: DIGIO2 INTERNATIONAL CO., LTD., MIAOLI (TW)

(21) Appl. No.: 13/845,629

(22) Filed: Mar. 18, 2013

(51) Int. Cl. G08B 21/02; B60Q 9/00

(52) U.S. Cl. CPC G08B 21/02; B60Q 9/00
USPC 340/576

(57) ABSTRACT

A health monitoring and warning system includes a cloud computing unit, a vehicle scheduling unit and a vehicle with a warning unit. An operator of the vehicle wears a healthcare monitoring device for measuring the physical condition thereof. The cloud computing unit monitors the physical condition of the operator and judges the physical condition is normal or not based on the data measured by the health monitoring chip. When the cloud computing unit judges the physical condition is abnormal, it transmits a warning signal to the vehicle scheduling unit and transmits a start signal to activate the warning unit, thereby warning the operator, passengers and people adjacent to the vehicle.

### BACKGROUND OF THE INVENTION

1. Field of the Invention

The present invention relates to a health monitoring and warning system, more especially to a system cooperating with a cloud computing unit, a vehicle scheduling unit and a healthcare monitoring device to monitor the physical condition of the operator of a vehicle instantly and to ensure the safety of the operator, passengers, vehicles and people adjacent to the vehicle.

2. The Prior Arts

As people survive longer, there are some news reporting that bus drivers died while operating the bus due to the myocardial infarction and hence the bus was overturned. When the bus is overturned, not only the driver and passengers get hurt, it also hinders the pedestrians, shops, vehicles . . . etc. nearby the buses and the hindrance is much serious than a general traffic accident. Therefore, every traffic company pays great attention to the health of vehicle operators.

However, it is noted that the physical condition of drivers in the traffic accidents was normal before driving; the fact shows that myocardial infarction is the major cause of the traffic accident. Myocardial infarction can be observed with the electrocardiography, and the health and life of the drivers can be saved by appropriate curing. Therefore, a system that can monitor instantly and generates warning signals for preventing accidents caused by this kind of myocardial infarction is urgently needed.

### SUMMARY OF THE INVENTION

An objective of the present invention is to provide a health monitoring and warning system which includes a cloud computing unit, at least one vehicle scheduling unit, and at least one vehicle. Each vehicle scheduling unit wirelessly communicates with the cloud computing unit, and each vehicle wirelessly communicates with the cloud computing unit and the vehicle scheduling unit. Furthermore, a warning unit wirelessly communicated with the cloud computing unit is installed on each vehicle. An operator of the vehicle wears a healthcare monitoring device to measure the physical condition thereof, and the cloud computing unit wirelessly communicates with the healthcare monitoring device to monitor the physical condition of the operator and judges if the physical condition is normal or not according to the data measured by the health monitoring chip. When the cloud computing unit judges the physical condition is abnormal, it transmits a warning signal to the vehicle scheduling unit, and transmits a start signal to activate the warning unit, thereby generating warning signals or signs in the form of light, sound or vibration.

The healthcare monitoring device generally measures an electrocardiogram (EGC or EKG) of the operator. The technical characteristic of the present invention is cooperating with a cloud computing unit, a vehicle scheduling unit and a healthcare monitoring device to monitor the physical condition of the operator of a vehicle instantly such that the safety of the operator, passengers and vehicles and people adjacent to the vehicle can be ensured.

### BRIEF DESCRIPTION OF THE DRAWINGS

The present invention can be understood in more detail by reading the subsequent detailed description in conjunction with the examples and references made to the accompanying drawings, wherein:

FIG. 1 is a schematic drawing illustrating the health monitoring and warning system of the present invention; and

FIG. 2 is a schematic drawing illustrating the operation of the health monitoring and warning system of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. Modifications of the shape of the present invention shall too be considered to be within the spirit of the present invention.

FIG. 1 is a schematic drawing illustrating the health monitoring and warning system of the present invention. As shown in FIG. 1, the health monitoring and warning system 1 of the present invention includes a cloud computing unit 10, at least one vehicle scheduling unit 20, and at least one vehicle 30, wherein each vehicle scheduling unit 20 manages at least one vehicle 30, and the vehicle 30 wirelessly communicates with the respective vehicle scheduling unit 20. An operator 31 of the vehicle 30 wears a healthcare monitoring device 40 for measuring the physical condition thereof, such as an electrocardiogram (EGC or EKG) of the operator. Each vehicle scheduling unit 20 wirelessly communicates with the cloud computing unit 10. The cloud computing unit 10 wirelessly communicates with each healthcare monitoring device 40 to judge the physical condition of the operator 31 is normal or not according the data measured by the healthcare monitoring device 40. In addition, a warning unit 35 wirelessly communicated with the cloud computing unit 10 is installed on each vehicle 30.

FIG. 2 is a schematic drawing illustrating the operation of the health monitoring and warning system of the present invention. Only a vehicle scheduling unit 20 and a vehicle 30 are shown in FIG. 2 to describe the technical characteristics simply and clearly, the amount of the scheduling unit 20 and a vehicle 30 is not limited and can changed according to the actual condition. As shown in FIG. 2, the operator 31 of the vehicle 30 wears a healthcare monitoring device 40 for measuring the physical condition, such as the electrocardiogram (EGC or EKG) of the operator. The healthcare monitoring device 40 has an antenna to communicate with a positioning unit 33 or a wireless unit 45 installed on the vehicle 30, then the positioning unit 33 or a wireless unit 45 transmits the data measured by the healthcare monitoring device 40 to the cloud computing unit 10.

The cloud computing unit 10 judges if the physical condition of the operator 31 is normal or not according the data measured by the healthcare monitoring device 40. When the cloud computing unit 10 judges the physical condition of the operator 31 is abnormal, it transmits a warning signal to the vehicle scheduling unit 20 to request for dispatching another operator to replace the operator 31 suffering from abnormal physical condition. At the same time, the cloud computing unit 10 also transmits a start signal to activate the warning unit 35. When the warning unit is activated, the operator 31 is requested to stop the vehicle 30, or to stop the vehicle 30 on the sideway slowly. Moreover, the vehicle scheduling unit 20 can request the operator 31 to stop the vehicle 30, or to stop the vehicle 30 on the sideway slowly via the radio broadcast. The vehicle 30 is selected from a group consisting of a truck, a bus, a crane, an excavator, a bulldozer, and a lift truck. The wireless unit 45 is preferably selected from a group consisting of a cell phone, a GPS system, a pad computer, and a notebook computer. The warning unit 35 includes at least one of a warning light, an alarm, and a buzzer.

Furthermore, the cloud computing unit 10 and/or the vehicle scheduling unit 20 wirelessly communicate(s) with a medical care facility 50 and/or a traffic safety facility 60. When the cloud computing unit 10 judges the physical condition of the operator 31 is abnormal, the cloud computing unit 10 and/or the vehicle scheduling unit 20 transmit(s) a help-seeking signal to the medical care facility 50 and/or the traffic safety facility 60 for seeking help.

The technical characteristic of the present invention is cooperating with a cloud computing unit, a vehicle scheduling unit and a healthcare monitoring device to monitor the physical condition of the operator of a vehicle instantly, such that the safety of the operator, passengers and vehicles and people nearby the vehicle can be ensured.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A health monitoring and warning system, comprising:
a cloud computing unit;
at least one vehicle scheduling unit wirelessly communicating with the cloud computing unit;
at least one vehicle wirelessly communicating with the vehicle scheduling unit; and
at least one warning unit disposed on the vehicle and wirelessly communicating with the cloud computing unit,
wherein, an operator of the vehicle wears a healthcare monitoring device for measuring the physical condition thereof, and the cloud computing unit wirelessly communicates with the healthcare monitoring device to monitor the physical condition of the operator and judges the physical condition normal or not according to the data measured by the health monitoring chip, and when the cloud computing unit judges the physical condition is abnormal, the cloud computing unit transmits a warning signal to the vehicle scheduling unit, and transmits a start signal to the warning unit, thereby activating the warning unit.

2. The health monitoring and warning system as claimed in claim 1, wherein the healthcare monitoring device measures an electrocardiogram (ECG or EKG) of the vehicle operator.

3. The health monitoring and warning system as claimed in claim 1, wherein the healthcare monitoring device has an antenna to wirelessly communicate with a positioning unit or a wireless unit installed on the vehicle, and the data measured by the healthcare monitoring device is transmitted to the cloud computing unit through the positioning unit or the wireless unit.

4. The health monitoring and warning system as claimed in claim 1, wherein the vehicle is one of a truck, a bus, a crane, an excavator, a bulldozer, and a lift truck.

5. The health monitoring and warning system as claimed in claim 3, wherein the wireless unit is one of a cell phone, a GPS system, a pad computer, and a notebook computer.

6. The health monitoring and warning system as claimed in claim 1, wherein the warning unit is selected from a group consisting of a warning light, an alarm, and a buzzer.

7. The health monitoring and warning system as claimed in claim 1, wherein the cloud computing unit and/or the vehicle scheduling unit are/is further wirelessly communicated with a medical care facility and/or a traffic safety facility, and the cloud computing unit and/or the vehicle scheduling unit transmits a help-seeking signal to the medical care facility and/or the traffic safety facility when the cloud computing unit judges the physical condition of the operator is abnormal.
